(19) United States
(12) Patent Application Publication
(10) Pub. No.: US 2026/0121389 A1
(43) Pub. Date: Apr. 30, 2026

(54) CABLE STRIPPING HAND TOOL WITH ADJUSTABLE BLADE

(71) Applicant: JETOOL CORP., New Taipei City (TW)

(72) Inventor: Chih-Lang Wang, New Taipei City (TW)

(73) Assignee: JETOOL CORP., New Taipei City (TW)

(21) Appl. No.: 19/248,488

(22) Filed: Jun. 25, 2025

(30) Foreign Application Priority Data
Oct. 28, 2024 (TW) 113140996

(51) Int. Cl. H02G 1/12

(52) U.S. Cl. CPC H02G 1/1231

(57) ABSTRACT

Provided is a cable stripping hand tool with an adjustable blade, including a first handle, a second handle, and an adjustable blade assembly. The first handle is pivotally connected to the second handle. The adjustable blade assembly is disposed in the first handle, including an adjusting column, a switching wheel, and a blade. The adjusting column is disposed through the first handle along an axis, having a profiled column body. The switching wheel is sleeved on the adjusting column, having a profiled hole adapted to the profiled column body, driving the adjusting column to rotate relative to the first handle along the axis and switching between two locations. The blade is disposed on the adjusting column, moving closer to or away from the second handle with a relative pivoting of the first handle and the second handle and switching to be presented in a lateral or longitudinal direction.

### CROSS-REFERENCE TO RELATED APPLICATION

This application claims the priority benefit of Taiwan application serial no. 113140996, filed on Oct. 28, 2024. The entirety of the above-mentioned patent application is hereby incorporated by reference herein and made a part of this specification.

### BACKGROUND

### Technical Field

The disclosure relates to a cable stripping hand tool, and in particular to a cable stripping hand tool with an adjustable blade.

### Description of Related Art

At present, various signal wires and signal connectors have been widely applied in signal transmission, such as network cables and RJ45 connectors for transmitting network signals, and telephone cables and RJ11 connectors for transmitting telephone signals. In order to connect the wire to the equipment, a terminal of the wire is usually connected to a corresponding connector to form a state of a cable connector. At this time, a specific wire crimping tool is used to connect and fix the wire and the connector to each other.

Generally speaking, before the cable connector is being processed, stripping the cable is often performed first. In the stripping process, different manners of cutting need to be performed to improve the stripping efficiency while avoiding damages to the internal core, or to meet different stripping needs. Therefore, existing cable stripping tools are often configured with multiple blades and carriers to facilitate users to select the corresponding blade and carrier. However, in this way, the cable needs to switch between different blades and carriers. Even multiple cable stripping tools are needed to meet the stripping needs of the cable.

### SUMMARY

The disclosure provides a cable stripping hand tool with an adjustable blade, which provides direction switching for a single blade, thereby completing cutting and stripping operations in different directions needed for a cable through a simple structural relationship.

The cable stripping hand tool according the disclosure includes a first handle, a second handle and an adjustable blade assembly. The first handle is pivotally connected to the second handle, and the adjustable blade assembly is disposed on the first handle. The adjustable blade assembly includes an adjusting column, a switching wheel and a blade. The adjusting column is disposed through the first handle along an axis and has a profiled column body. The switching wheel is sleeved on the adjusting column and has a profiled hole to adapt to the profiled column body. The switching wheel drives the adjusting column to rotate relative to the first handle along the axis and switch between two locations. The blade is disposed on the adjusting column. The blade moves closer to or away from the second handle with a relative pivoting of the first handle and the second handle, and switches between the two locations with the adjusting column to be presented in a lateral direction or a longitudinal direction.

In an embodiment of the disclosure, the adjustable blade assembly further includes a spring and a positioning ball stored in a receiving hole of the switching wheel and rotating along the axis with the switching wheel. The spring is abutted between the switching wheel and the positioning ball, and the spring constantly drives the positioning ball to be abutted to the first handle.

In an embodiment of the disclosure, a top surface of the first handle has two positioning recesses located on a movement path of the positioning ball to position the switching wheel and the adjusting column at one of the two locations when a part of the positioning ball falls into one of the positioning recesses.

In an embodiment of the disclosure, a top surface of the first handle has a retaining wall, and the switching wheel has two stop portions. Two opposite ends of the retaining wall are respectively on movement paths of the two stop portions to position the switching wheel at one of the two locations when the stop portion is stopped at one of the ends of the retaining wall.

In an embodiment of the disclosure, the adjustable blade assembly further includes two supporting rods disposed through the first handle, and the switching wheel further has an annular groove. The two supporting rods respectively pass through two opposite sides of the annular groove along a tangential direction of the annular groove to allow the switching wheel to be rotatably positioned on the two supporting rods along the axis.

In an embodiment of the disclosure, the lateral direction and the longitudinal direction are perpendicular to each other.

In an embodiment of the disclosure, the profiled hole is adapted to the profiled column body to allow the adjusting column to be movably disposed through the switching wheel along the axis, and avoid the switching wheel and the adjusting column from relatively pivoting along the axis.

In an embodiment of the disclosure, the adjustable blade assembly further includes an adjusting wheel, the adjusting column further has a screw column body, and an internal thread of the adjusting wheel is adapted to an external thread of the screw column body to allow the adjusting wheel to be rotatably sleeved on the adjusting column along the axis and drive the adjusting column to move along the axis.

In an embodiment of the disclosure, the blade is embedded in one end of the screw column body and away from the profiled column body.

In an embodiment of the disclosure, the first handle has a groove, a first through via and a second through via all located on the axis. The groove is located between the first through via and the second through via. The profiled hole of the switching wheel is located on the first through via. An annular groove of the switching wheel is located in the first through via. The screw column body extends from the groove to the second through via. The blade is located under the second through via.

In an embodiment of the disclosure, another spring is further included, which is abutted between the first handle and the second handle.

In an embodiment of the disclosure, a carrier is further included, which is detachably assembled to a receiving groove of the second handle. The blade moves closer to or away from the carrier with the relative pivoting of the first handle and the second handle. A cable is adapted to bear on the carrier. The longitudinal direction is consistent with an extension direction of the cable, and the lateral direction is a cross-sectional direction of the cable.

Based on the above, the cable stripping hand tool includes the first handle and the second handle that are pivotally connected to each other, and the adjustable blade assembly disposed on the first handle. The adjustable blade assembly includes the adjusting column and the switching wheel. The adjusting column is disposed through the first handle along an axis and has the profiled column body. The switching wheel is sleeved on the adjusting column and has the profiled hole to adapt the profiled column body. The blade is disposed on the adjusting column. In this way, due to the adapting relationship between the profiled hole and the profiled column body, the user may use the switching wheel to drive the adjusting column to pivot relative to the first handle along the axis, and drive the blade to switch between the lateral state and the longitudinal state in order to convert directions with merely one single blade to provide the user with cutting effects in different directions for the cable, thus eliminating the inconvenience caused by switching during the stripping process.

### BRIEF DESCRIPTION OF THE DRAWINGS

FIG. 1 is a schematic view of a cable stripping hand tool according to an embodiment of the disclosure.

FIG. 2 is the cable stripping hand tool in FIG. 1 from another perspective.

FIG. 3 and FIG. 4 are exploded views of a cable stripping hand tool respectively from different perspectives.

FIG. 5A is a partial enlarged view of a cable stripping hand tool in an using state.

FIG. 5B and FIG. 5C are partial cross-sectional views of the cable stripping hand tool in FIG. 5A respectively in different cross-sections.

FIG. 5D is a corresponding relationship between a switching wheel and supporting rods.

FIG. 6A is a partial enlarged view of a cable stripping hand tool in another using state.

FIG. 6B and FIG. 6C are partial cross-sectional views of the cable stripping hand tool in FIG. 6A respectively in different cross-sections.

### DESCRIPTION OF THE EMBODIMENTS

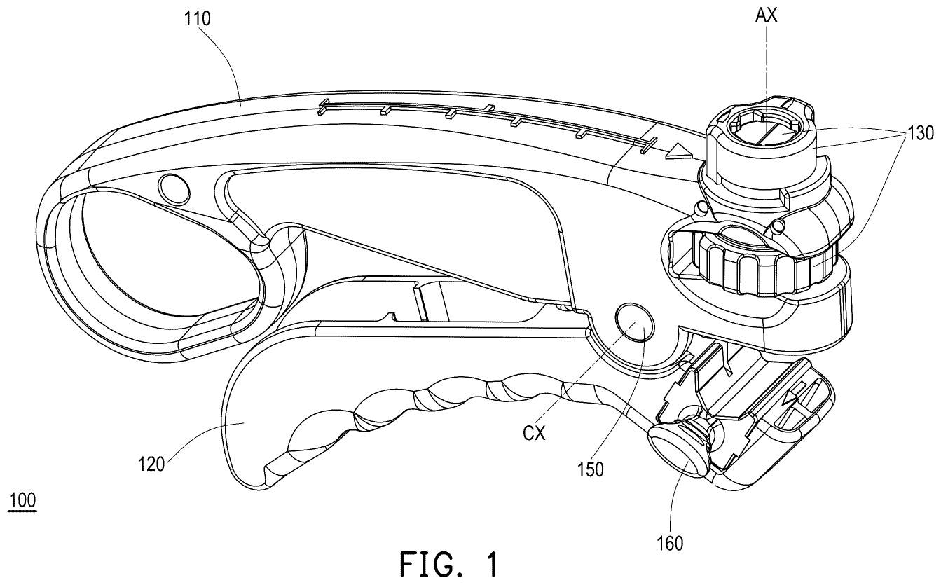

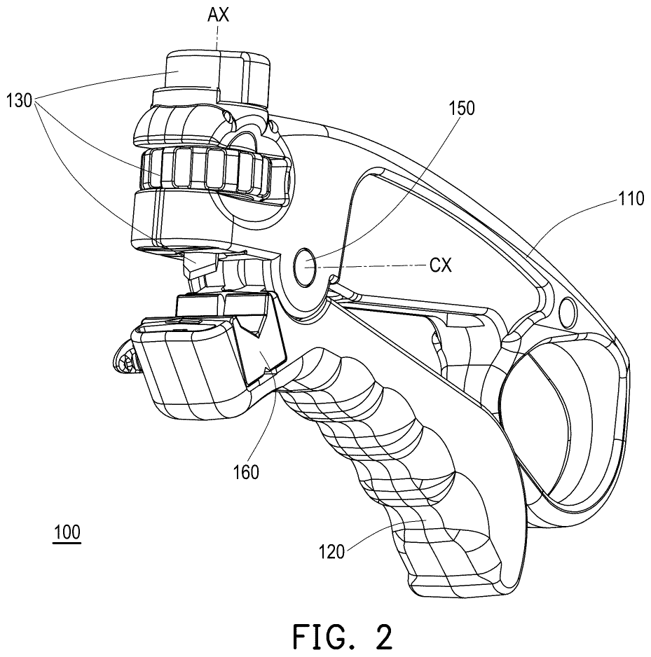

FIG. 1 is a schematic view of a cable stripping hand tool according to an embodiment of the disclosure. FIG. 2 is the cable stripping hand tool in FIG. 1 from another perspective. Please refer to FIG. 1 and FIG. 2 at the same time. In the embodiment, a cable stripping hand tool 100 with an adjustable blade (hereinafter referred to as the cable stripping hand tool 100) includes a first handle 110 and a second handle 120 that are pivotally connected to each other, and an adjustable blade assembly 130 disposed on the first handle 110. The first handle 110 and the second handle 120 are connected together through a hinge 150 to facilitate a relative pivoting along an axis CX for the user to hold and press one side (not shown here, may refer to subsequent figures and descriptions) and allow the cable to be cut and stripped by the adjustable blade assembly 130 on the other side.

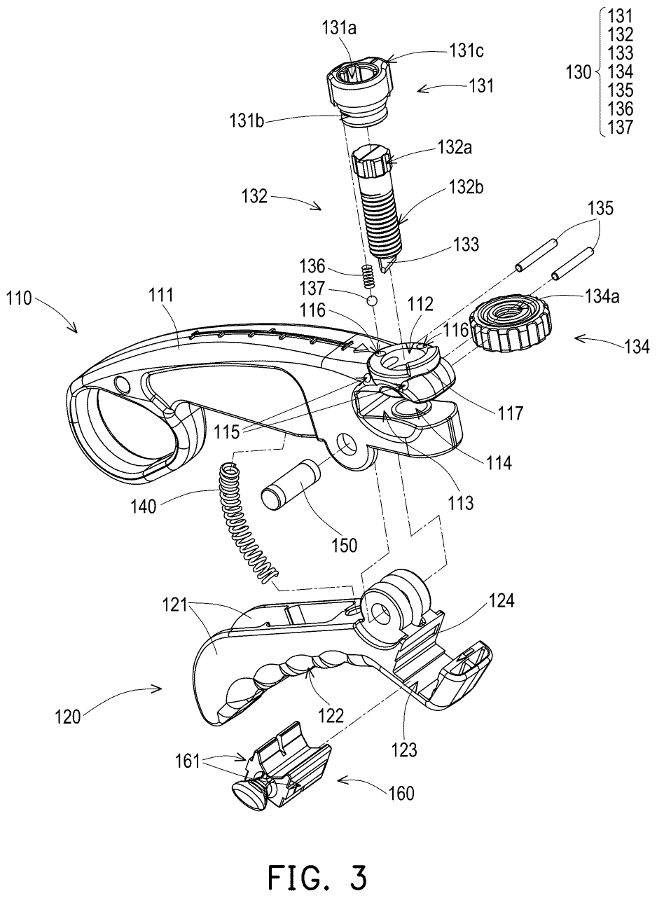

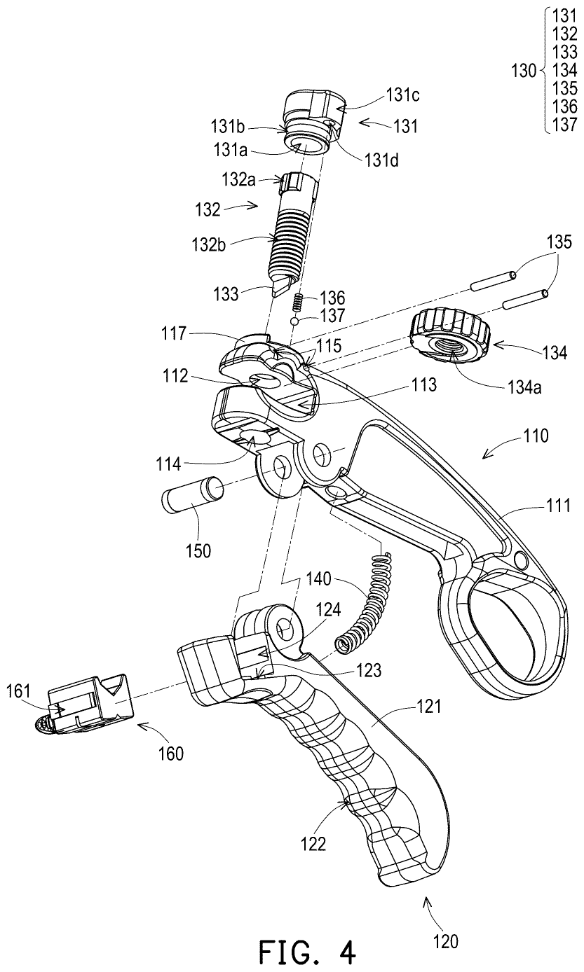

FIG. 3 and FIG. 4 are exploded views of a cable stripping hand tool respectively from different perspectives. Please refer to FIG. 3 and FIG. 4 at the same time. After the first handle 110 and the second handle 120 are pivotally connected to allow each other to relatively pivot, the cable stripping hand tool 100 of the embodiment further includes a spring 140 and a carrier 160. The spring 140 is abutted between the first handle 110 and the second handle 120. The carrier 160 is detachably assembled to a receiving groove 123 of the second handle 120, and a blade 133 moves closer to or away from the carrier 160 with the relative pivoting of the first handle 110 and the second handle 120, and the cable (not shown in FIG. 3 and FIG. 4, may refer to the following figures) is adapted to bear on the carrier 160. As shown in FIG. 3 and FIG. 4, the second handle 120 further has concave rails 124 on two opposite side walls in the receiving groove 123, and the carrier 160 has a pair of convex rails 161 on opposite sides to facilitate the docking of the carrier 160 through the convex rails 161 and the concave rails 124 to smoothly move into or out of the receiving groove 123. In addition, the spring 140 constantly drives the first handle 110 and the second handle 120 away from each other at the part where the spring 140 is abutted. That is, a user holding a handle body 111 of the first handle 110 and a holding portion 122 on a handle body 121 of the second handle 120 and applying pressure to overcome an elastic force of the spring 140 enables the cable stripping hand tool 100, as shown in FIG. 1 or FIG. 2, to allow the blade 133 to move away from the carrier 160. When the user stops exerting force, the elastic force of the spring 140 is able to allow the first handle 110 and the second handle 120 to return and allow the blade 133 to move away from the carrier 160.

In addition, please refer to FIG. 3 and FIG. 4 at the same time. In the embodiment, the adjustable blade assembly 130 includes an adjusting column 132, a switching wheel 131 and the blade 133. The adjusting column 132 is disposed through the first handle 110 along an axis AX (marked in FIG. 1 and FIG. 2). The adjusting column 132 has a profiled column body 132a. The switching wheel 131 is sleeved on the adjusting column 132, and the switching wheel 131 has a profiled hole 131a to adapt to the profiled column body 132a of the adjusting column 132 to allow the switching wheel 131 to drive the adjusting column 132 to rotate relative to the first handle 110 along the axis AX and switch between two locations.

Please refer to FIG. 3 and FIG. 4 and compare with FIG. 1 or FIG. 2. The adaptation of the profiled hole 131a and the profiled column body 132a here means that the inner hole wall of the switching wheel 131 and the outer column surface of the adjusting column 132 do not have circular or cylindrical profiles, but have random protrusions or recesses relative to the axis AX to allow the profiles to be complementary to each other. This allows the adjusting column 132 to be movably disposed through the switching wheel 131 along the axis AX, and avoids the switching wheel 131 and the adjust column 132 from generating the relative pivoting along the axis AX. That is, when the user is driving the switching wheel 131 to rotate along the axis AX, the adjusting column 132 may be simultaneously and synchronously driven to rotate along the axis AX without idling.

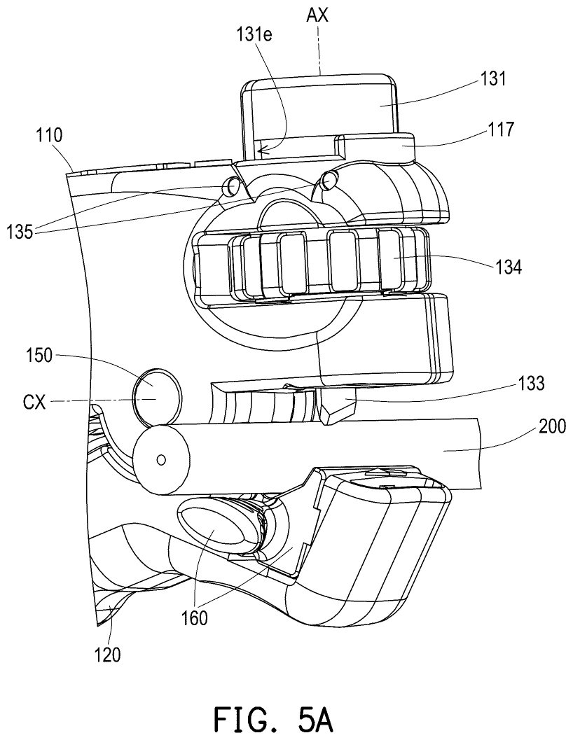

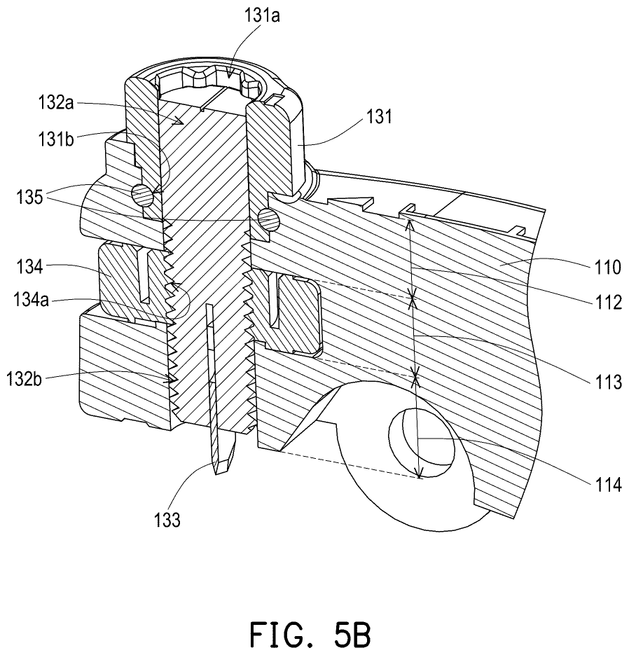

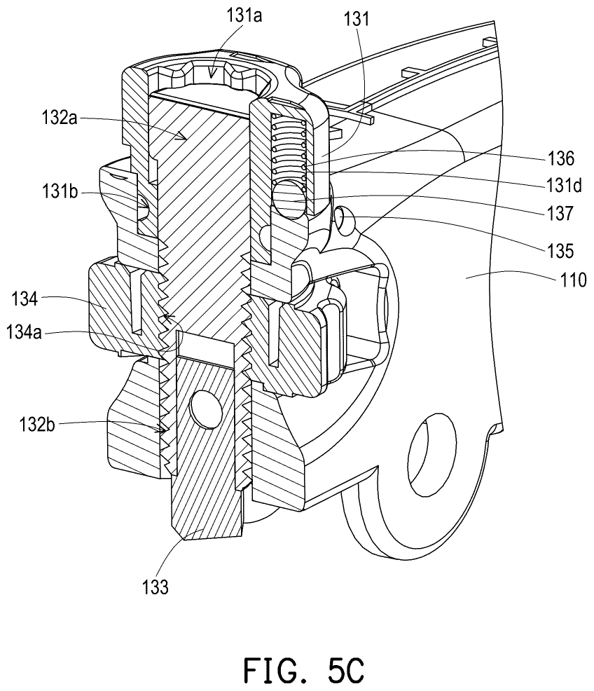

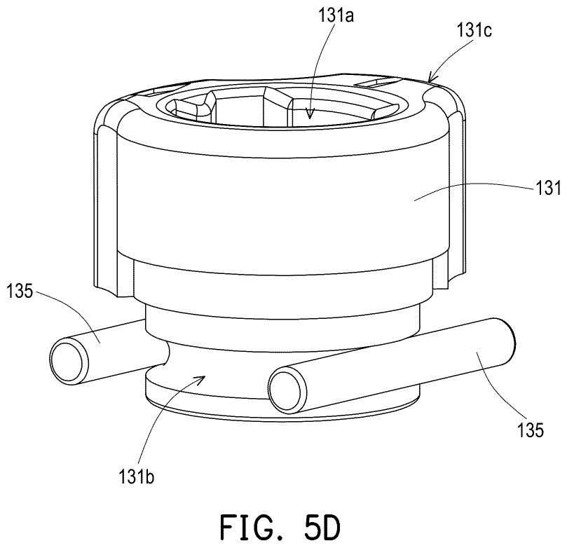

FIG. 5A is a partial enlarged view of a cable stripping hand tool in an using state. FIG. 5B and FIG. 5C are partial cross-sectional views of the cable stripping hand tool in FIG. 5A respectively in different cross-sections. FIG. 5D is a corresponding relationship between a switching wheel and supporting rods. Please refer to FIG. 3, FIG. 5B and FIG. 5D. In the embodiment, the adjustable blade assembly 130 further includes two supporting rods 135 disposed through the first handle 110, and the switching wheel 131 further has an annular groove 131b. The supporting rods 135 respectively pass through opposite sides of the annular groove 131b along a tangential direction of the annular groove 131b to allow the switching wheel 131 to be rotatably positioned on the two supporting rods 135 along the axis AX. As shown in FIG. 3, the first handle 110 has a first through via 112 (can be regarded as a longitudinal through via) and a pair of lateral through vias 115. The lateral through vias 115 generate a broken surface on the hole wall of the first through via 112, so that the supporting rod 135 disposed through the lateral through vias 115 may be exposed from the broken surface on the hole wall of the first through via 112 and protrude from the hole wall as to allow the switching wheel 131 with a partial structure disposed through the first through via 112 to be engaged with the pair of supporting rods 135 by the annular groove 131b and positioned on the first handle 110 (to avoid the switching wheel 131 from moving along the axis AX).

Furthermore, the adjustable blade assembly 130 further includes a spring 136 and a positioning ball 137 that are stored in a receiving hole 131d of the switching wheel 131 and rotate along the axis AX with the switching wheel 131. The spring 136 is abutted between the switching wheel 131 and the positioning ball 137, and the spring 136 constantly drives the positioning ball 137 to be abutted to the first handle 110. Based on this, the spring 136 and the positioning ball 137 in the receiving hole 131d may rotate relative to the first handle 110 along the axis AX with the switching wheel 131. During the process of rotation, the positioning ball 137 being pressed by the spring 136 is constantly abutted to a top surface of the first handle 110 as a result. In addition, the top surface of the first handle 110 further has two positioning recesses 116 that are located on the movement path of the positioning ball 137, so that when a part of the positioning ball 137 falls into one of the positioning recesses 116, the switching wheel 131 and the adjusting column 132 are positioned at one of the two locations.

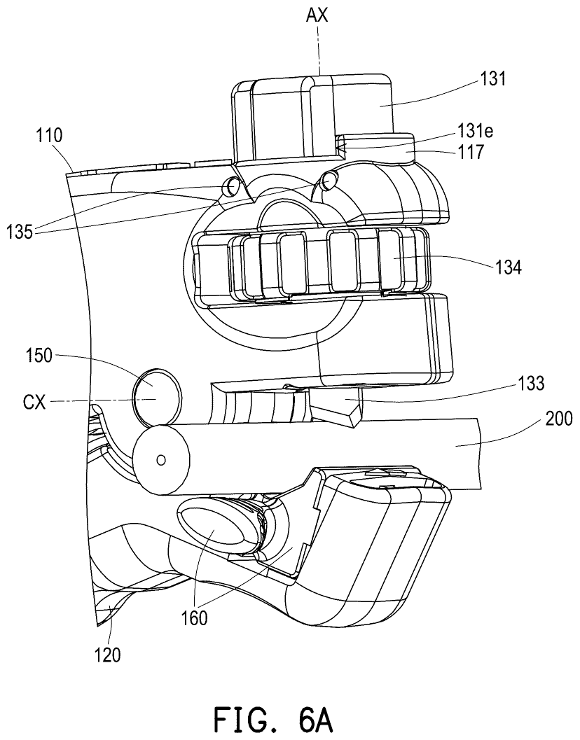

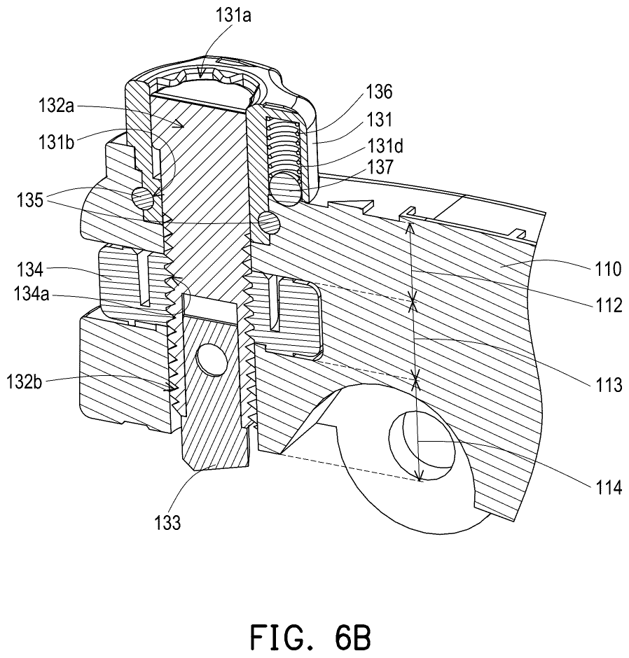

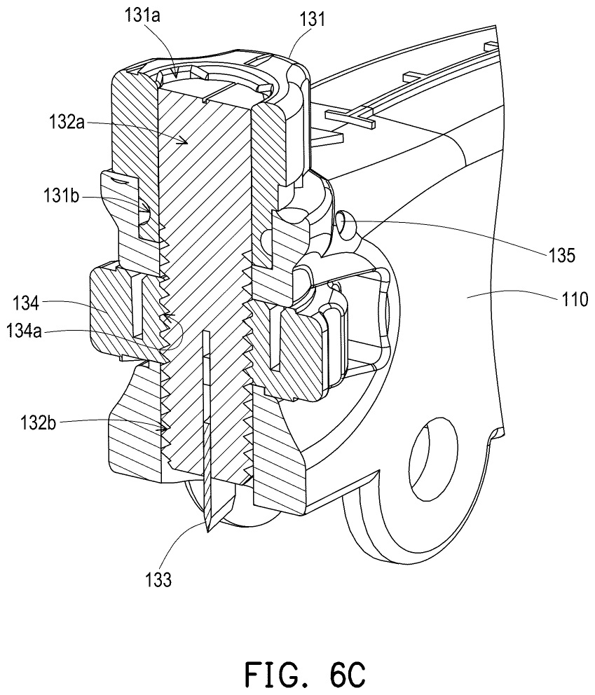

FIG. 6A is a partial enlarged view of a cable stripping hand tool in another using state. FIG. 6B and FIG. 6C are partial cross-sectional views of the cable stripping hand tool in FIG. 6A respectively in different cross-sections. Please refer to FIG. 5A and FIG. 6A first and compare with FIG. 3 or FIG. 4. The top surface of the first handle 110 further has a retaining wall 117, and the switching wheel 131 has two stop portions 131e. FIG. 5A and FIG. 6A show one of the stop portions 131e. The opposite ends of the retaining wall 117 are respectively on the movement paths of the two stop portions 131e, so that when the stop portion 131e is stopped by one end of the retaining wall 117, the switching wheel 131 is positioned at one of the two locations. Here, the retaining wall 117 and the stop portions 131e of the switching wheel 131 serve as the final stop for the switching wheel 131 rotating along the axis AX to assist and ensure the foregoing positioning effect that is generated through the positioning ball 137 falling into the positioning recess 116.

Furthermore, FIG. 5A and FIG. 6A represent different states of the switching wheel 131 switching between the two locations based on the foregoing structure. The blade 133 is converted into a longitudinal state shown in FIG. 5A and a lateral state shown in FIG. 6A due to the switching wheel 131 driving the adjusting column 132 to rotate. Here, taking a cable 200 as a reference, the longitudinal state of the blade 133 means that the blade is consistent with an extension direction of the cable 200, and the lateral state of the blade 133 means that the blade is consistent with a cross-sectional direction of the cable 200. The lateral direction and the longitudinal direction are perpendicular to each other. This may also be clearly reflected by a 90-degree central angle formed by the two positioning recesses 116 relative to the axis AX.

Please refer to FIG. 3 and FIG. 4 again. In the embodiment, the adjustable blade assembly 130 further includes an adjusting wheel 134, and the adjusting column 132 further has a screw column body 132b, and an internal thread 134a of the adjusting wheel 134 is adapted to an external thread of the screw column body 132b to allow the adjusting wheel 134 to be rotatably sleeved on the screw column body 132b of the adjusting column 132 along the axis AX and drive the adjusting column 132 to move along the axis AX.

Furthermore, the first handle 110 further has a groove 113, a second through via 114 and the foregoing first through via 112, and all three are located on the axis AX. In terms of the configuration along the axis AX, the groove 113 is located between the first through via 112 and the second through via 114. The profiled hole 131a of the switching wheel 131 is located on the first through via 112, the annular groove 131b of the switching wheel 131 is located in the first through via 112, the screw column body 132b extends from the groove 113 to the second through via 114, and the blade 133 is located under the second through via 114. The blade 133 is substantially embedded in one end of the screw column body 132b and away from the profiled column body 132a.

It can also be clearly seen from FIG. 5A or FIG. 6C that due to the adapting relationship between the switching wheel 131 and (the profiled column body 132a of) the adjusting column 132, the switching wheel 131 and the adjusting column 132 may not rotate relative to each other along the axis AX, but may relatively move along the axis AX. This allows the adjusting wheel 134 to drive (the screw column body 132b of) the adjusting column 132 to move up and down (along the axis AX) through the adapted thread, and allows the user to drive the blade 133 to move toward the carrier 160 or away from the carrier 160.

In summary, in the foregoing embodiment of the disclosure, the cable stripping hand tool includes the first handle and the second handle that are pivotally connected to each other, and the adjustable blade assembly disposed on the first handle. The adjustable blade assembly includes the adjusting column and the switching wheel. The adjusting column is disposed through the first handle along an axis and has the profiled column body. The switching wheel is sleeved on the adjusting column and has a profiled hole to adapt to the profiled column body. The blade is disposed on adjusting column.

It is specially noted that the switching wheel, the adjusting column and the adjusting wheel are coaxially disposed on the first handle. The profiled hole of the switching wheel and the profiled column body of the adjusting column are adapted to each other to allow the switching wheel and the adjusting column to generate a movement effect that may move relative to the axis but may not rotate relative to the axis. That is, the user may merely rotate the switching wheel to synchronously drive the adjusting column to rotate, so the steering of the blade can be achieved. Furthermore, the internal thread of the adjusting wheel and the screw column body of the adjusting column are adapted to each other, so the user can achieve the effect of moving the adjusting column along the axis through rotating the adjusting wheel to adjust a relative distance between the blade and the carrier.

In this way, due to the adapting relationship between the profiled hole and the profiled column body, the user may use the switching wheel to drive the adjusting column to pivot relative to the first handle along the axis, and drive the blade to switch between the lateral state and the longitudinal state in order to convert directions with merely one single blade without affecting the adjustment of the relative distance between the blade and the carrier to provide the user with cutting effects in different directions for the cable, thus eliminating the inconvenience caused by switching during the stripping process.

What is claimed is:

1. A cable stripping hand tool with an adjustable blade, comprising:
a first handle;
a second handle, pivotally connected to the first handle; and
an adjustable blade assembly, disposed on the first handle, comprising:
an adjusting column, disposed through the first handle along an axis, and having a profiled column body;
a switching wheel, sleeved on the adjusting column, having a profiled hole to adapt to the profiled column body, driving the adjusting column to rotate relative to the first handle along the axis, and switching between two locations; and
a blade, disposed on the adjusting column, moving closer to or away from the second handle with a relative pivoting of the first handle and the second handle, and switching between the two locations with the adjusting column to be presented in a lateral direction or a longitudinal direction.

2. The cable stripping hand tool according to claim 1, wherein the adjustable blade assembly further comprises a spring and a positioning ball stored in a receiving hole of the switching wheel and rotating along the axis with the switching wheel, the spring is abutted between the switching wheel and the positioning ball, and the spring constantly drives the positioning ball to be abutted to the first handle.

3. The cable stripping hand tool according to claim 2, wherein a top surface of the first handle has two positioning recesses located on a movement path of the positioning ball to position the switching wheel and the adjusting column at one of the two locations when a part of the positioning ball falls into one of the positioning recesses.

4. The cable stripping hand tool according to claim 1, wherein a top surface of the first handle has a retaining wall, the switching wheel has two stop portions, and two opposite ends of the retaining wall are respectively on movement paths of the two stop portions to position the switching wheel at one of the two locations when the stop portion is stopped at one of the ends of the retaining wall.

5. The cable stripping hand tool according to claim 1, wherein the adjustable blade assembly further comprises two supporting rods disposed through the first handle, the switching wheel further has an annular groove, and the two supporting rods respectively pass through two opposite sides of the annular groove along a tangential direction of the annular groove to allow the switching wheel to be rotatably positioned on the two supporting rods along the axis.

6. The cable stripping hand tool according to claim 1, wherein the lateral direction and the longitudinal direction are perpendicular to each other.

7. The cable stripping hand tool according to claim 1, wherein the profiled hole is adapted to the profiled column body to allow the adjusting column to be movably disposed through the switching wheel along the axis, and avoid the switching wheel and the adjusting column from relatively pivoting along the axis.

8. The cable stripping hand tool according to claim 1, wherein the adjustable blade assembly further comprises an adjusting wheel, the adjusting column further has a screw column body, and an internal thread of the adjusting wheel is adapted to an external thread of the screw column body to allow the adjusting wheel to be rotatably sleeved on the adjusting column along the axis and drive the adjusting column to move along the axis.

9. The cable stripping hand tool according to claim 8, wherein the blade is embedded in one end of the screw column body and away from the profiled column body.

10. The cable stripping hand tool according to claim 9, wherein the first handle has a groove, a first through via and a second through via all located on the axis, the groove is located between the first through via and the second through via, the profiled hole of the switching wheel is located on the first through via, an annular groove of the switching wheel is located in the first through via, the screw column body extends from the groove to the second through via, and the blade is located under the second through via.

11. The cable stripping hand tool according to claim 1, further comprising another spring abutted between the first handle and the second handle.

12. The cable stripping hand tool according to claim 1, further comprising a carrier detachably assembled to a receiving groove of the second handle, the blade moving closer to or away from the carrier with the relative pivoting of the first handle and the second handle, and a cable adapted to bear on the carrier, wherein the longitudinal direction is consistent with an extension direction of the cable, and the lateral direction is a cross-sectional direction of the cable.
